(19) United States
(12) Patent Application Publication
(10) Pub. No.: US 2024/0337144 A1
(43) Pub. Date: Oct. 10, 2024

(54) ACTUATION DEVICE FOR CHARGING PORT SOCKET CAP OR COVER

(71) Applicant: ILLINOIS TOOL WORKS INC., Glenview, IL (US)

(72) Inventors: Roland OCH, Rottendorf (DE); Thomas LECHNER-WATZLIK, Weikersheim (DE); Gunther MAIERHOFER, Erlangen (DE)

(21) Appl. No.: 18/626,991

(22) Filed: Apr. 4, 2024

Related U.S. Application Data
(60) Provisional application No. 63/494,715, filed on Apr. 6, 2023.

(51) Int. Cl. E05F 11/02; B60L 53/16; H01R 13/453

(52) U.S. Cl. CPC E05F 11/02; B60L 53/16; H01R 13/4536; E05Y 2201/71; E05Y 2900/534; H01R 2201/26

(57) ABSTRACT

An actuation device for moving a charging port socket cover of a charging port socket from a closed position to an access position, where the charging port socket is received or receivable on a body component of a vehicle, includes a movable actuation structure associated with the charging port socket cover and configured such that movement of a charging gun into contact with the actuation structure and toward the charging port causes the actuation structure to shift the charging port socket cover from the closed position toward the access position.

### TECHNICAL FIELD

The present invention relates generally to covers used for charging port sockets located in charging port housings and, more particularly, to actuation devices for movement of charging port socket covers in charging compartments that are received or receivable on or in a body component of a vehicle.

### BACKGROUND

Vehicles with a hybrid or electric drive usually have one battery or traction battery, which, for example in the case of PHEV vehicles (PHEV=plug-in hybrid electric vehicle) or BEV vehicles (BEV=battery electric vehicle), can be charged via an electrical charging connector that is accessible from the outside on the vehicle body, and is typically a charging port, by connecting to an electrical charging station, for example, or a conventional external electrical terminal.

The charging port is usually arranged in a charging compartment of the vehicle body, which is covered or closed by a charging flap that can be opened to access the charging compartment. Such charging compartments may typically include both an AC charging port socket and a DC charging port socket, where the DC charging port socket is utilized for higher speed charging. The DC charging port socket may be immediately below the AC charging port socket. Once the charging flap is opened, the two charging port sockets may be accessible. In some cases, the DC charging port socket may have a cap or cover that overlies the pins of the DC charging port socket to protect the DC pins when the AC charging port socket is being used for charging purposes. The cap or cover is commonly manually movable by an operator, e.g., by use of the hand to move the cap or cover out of the way (as by pulling or pivoting of the cap or cover) into a non-covering position. The operator can then connect the charge gun to the uncovered DC charging port socket for high speed charging purposes.

It would be desirable to eliminate the need for the separate step of moving the charging port socket cap or cover before placement of the charge gun toward the DC charging port.

### SUMMARY

In one aspect, a protective cover that is arranged so to be able to close the DC charging port section of a charging port socket. This cover is kept in a closed, port covering position by spring load or other bias. When a DC charging gun is inserted toward the DC charging port section, mechanical structure is actuated by the charging gun and transmits the motion of the charging gun into an actuation moves the protective cover to an access position in which the DC charging port pins are no longer covered and can be engaged by the charging gun. In embodiments, the movement of the protective cover from the closed position to the access position may be a rotational and/or sliding movement.

In another aspect, an actuation device for moving a charging port socket cover of a charging port socket from a closed position to an access position, where the charging port socket is received or receivable on a body component of a vehicle. The actuation device comprises a movable actuation structure associated with the charging port socket cover and configured such that movement of a charging gun into contact with the actuation structure and toward the charging port causes the actuation structure to shift the charging port socket cover from the closed position toward the access position.

In embodiments, the actuation structure is pivotable and the charging port socket cover is pivotable.

In embodiments, the actuation structure comprises at least one actuation component mounted for pivot about an upright axis and the charging port socket cover comprises at least one cover component mounted for pivot about a horizontal axis.

In embodiments, the actuation structure comprises at least one actuation component mounted for pivot about a horizontal axis and the charging port socket cover comprises at least one cover component mounted for pivot about a horizontal axis.

In embodiments, the actuation structure comprises at least one actuation component mounted for pivot about a first pivot axis and the charging port socket cover comprises at least one cover component mounted for pivot about a second pivot axis.

In embodiments, the first pivot axis and the second pivot axis are not parallel with each other.

In embodiments, the first pivot axis is an upright axis and the second pivot axis is a horizontal axis.

In embodiments, the first pivot axis is substantially parallel to the second pivot axis.

In embodiments, the first pivot axis is a horizontal axis and the second pivot axis is a horizontal axis.

In embodiments, the actuation structure is pivotable and the charging port socket cover is slidable along a guide path.

In embodiments, the actuation structure is also pivotably connected to the charging port socket cover.

In embodiments, a pivot axis of a pivot connection between the actuation structure and the charging port socket cover is moved as the charging gun moves the actuation structure.

In embodiments, the guide path is at least partly outward and downward from the charging port socket.

In embodiments, the actuation structure is biased into a set position that corresponds to the closed position of the charging port socket cover such that, upon removal of the charging gun, the actuation structure automatically returns to the set position and the charging port socket cover automatically returns to the closed position.

In embodiments, the actuation structure is interconnected with the charging port socket cover by: at least one gear connection to translate movement of the actuation structure into movement of the charging port socket cover; and/or at least one cammed connection to translate movement of the actuation structure into movement of the charging port socket cover; and/or at least one levered connection to translate movement of the actuation structure into movement of the charging port socket cover; and/or at least one pivot connection to translate movement of the actuation structure into movement of the charging port socket cover.

In another aspect, a method of operating a charging system of a vehicle involves: utilizing a charging port socket with a charging port socket cover that is movable from a closed position to an access position, wherein an actuation structure is linked to the charging port socket cover for moving the charging port socket cover; and moving a charging device toward the charging port socket and into engagement with the actuation structure causing a movement of the actuation structure that, in turn, causes the charging port socket cover to move from the closed position to the access position such that the charging device can engage with the charging port socket.

In a further aspect, a vehicle charging assembly includes a charging compartment within a vehicle body component, a charging port socket in the charging compartment and a charging port socket cover movable from a closed position that covers the charging port socket and an access position that uncovers the charging port socket. A movable actuation structure is linked to the charging port socket cover and configured such that movement of the actuation structure out of a set position shifts the charging port socket cover from the closed position toward the access position.

### BRIEF DESCRIPTION OF THE DRAWINGS

FIGS. 1-7 and 1A show one embodiment of an actuation device of charging port system;

FIGS. 8A-8C shown additional perspective views of the actuation device, where FIG. 8A shows no charging, FIG. 8B shows AC charging, with DC charging port socket cover remaining closed, and FIG. 8C shows DC charging, with the DC charging port socket cover moved to the access position by the charging gun;

FIGS. 9A-9C shown perspective views of an alternative embodiment, where FIG. 9A shows no charging, FIG. 9B shows AC charging, with DC charging port socket cover remaining closes, and FIG. 9C shows DC charging, with the DC charging port socket cover moved to the access position by the charging gun;

FIGS. 10A-10C show perspective views of another alternative embodiment, where FIG. 10A shows no charging, FIG. 10B shows AC charging, with DC charging port socket cover remaining closes, and FIG. 10C shows DC charging, with the DC charging port socket cover moved to the access position by the charging gun; and

FIGS. 11 and 12 show perspective views of another embodiment with charging port socket cover in closed and access positions, respectively;

FIGS. 13-14 shows views with a charging gun ready to be engaged into the charging port(s) for charging, with some portions hidden for clarity;

FIGS. 15-16 shows views with a charging gun engaged into the charging port(s) for charging, with some portions hidden for clarity; and

FIGS. 17-18 show perspective views of portions of the device.

### DETAILED DESCRIPTION

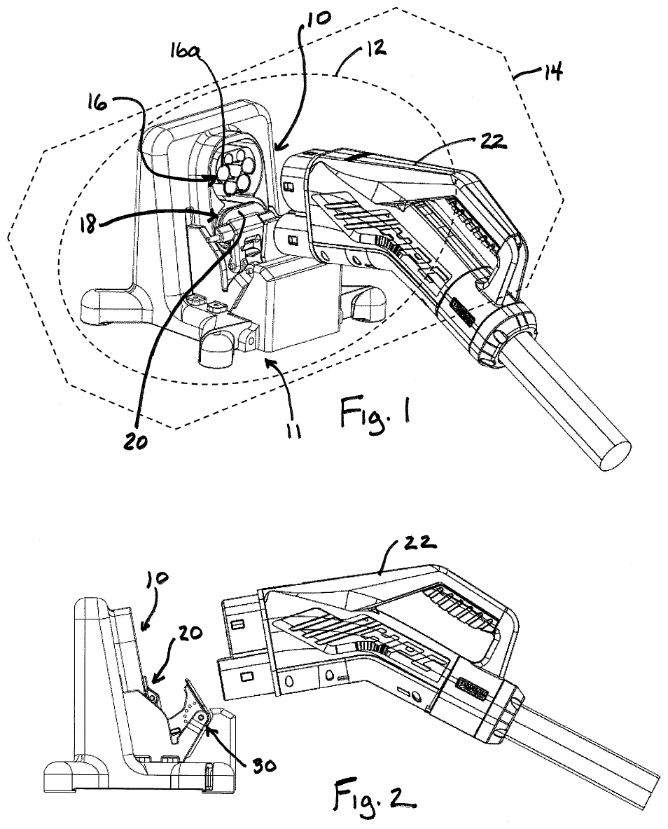

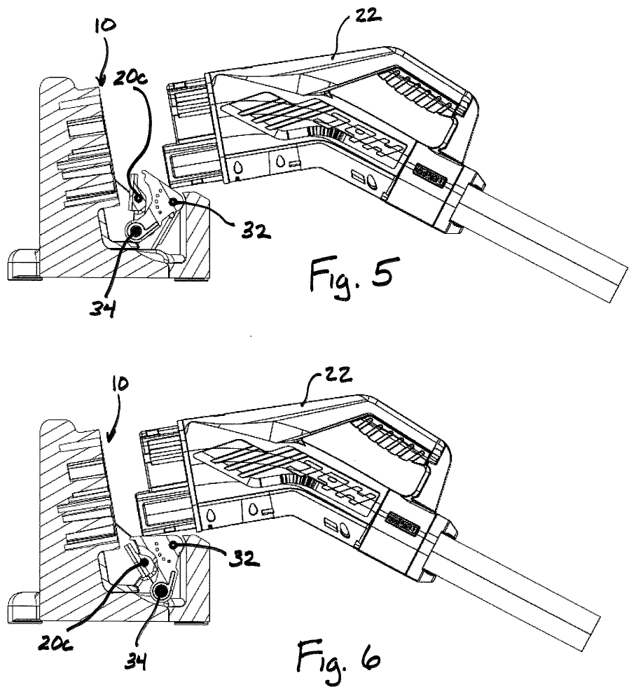

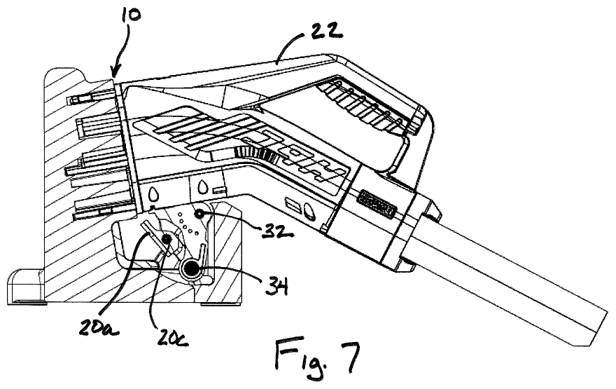

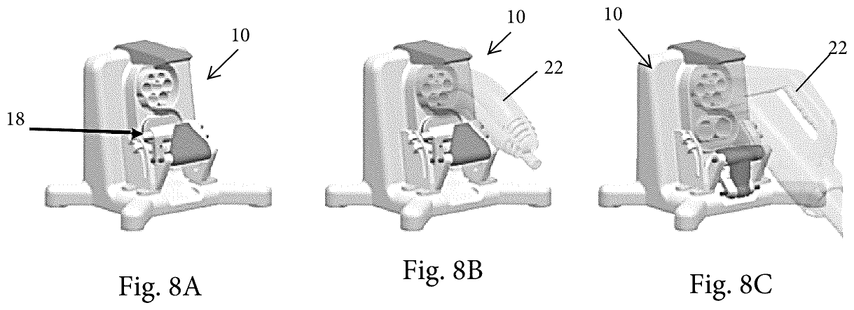

Referring to FIGS. 1-7, a charging system includes a charging housing 10 which may be located in a charging compartment 11 accessible via an opening 12 of a vehicle body component 14 (e.g., a body panel). The housing 10 defines an AC charging port socket 16, with associated pins located in pin openings 16a, and a DC charging port socket 18, with associated pins located in pin openings 18a. The DC charging port socket includes an associated charging port socket cover 20 that, in a closed position (per FIGS. 1-4) covers and protects the pins of the DC charging port socket 18, and that is movable to an access position (per FIG. 7) that uncovers the DC charging port socket 18 and enables a charging gun 22 to engage with the DC charging port socket 18. Intermediate positions of the charging port socket cover between the closed position the access position are shown in FIGS. 5-6.

Here, the charging port socket cover 20 includes a main cover plate 20a engageable over the DC charging port socket 18 when in the closed position, and an operating arm or arms 20b extending from the main cover plate 20a, with a pair of side pins 20c extending from the operating arm or arms 20b and ridable along a guide path defined by outwardly facing surfaces of respective side rails 22. An actuation device 30 includes an actuation plate component 30a that is mounted for pivotable movement about a horizontal pivot axis 32. The actuation device further includes an arm or arms 30b that extend from and pivot with the plate component 30a, and which are pivotably connected to a distal portion of the operating arm 20b such that the actuation device 30 and the cover 20 can pivot relative to each other about a horizontal pivot axis 34. Here, the pivot axis 32 is substantially parallel to the pivot axis 34.

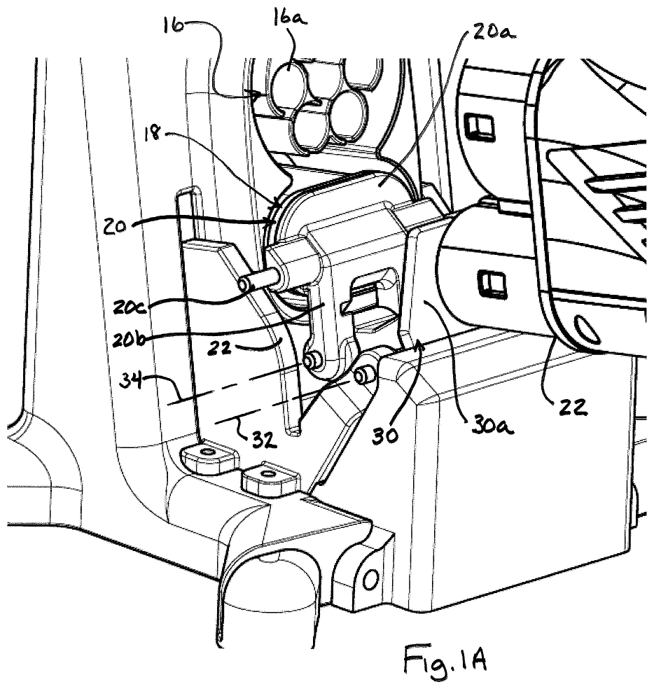

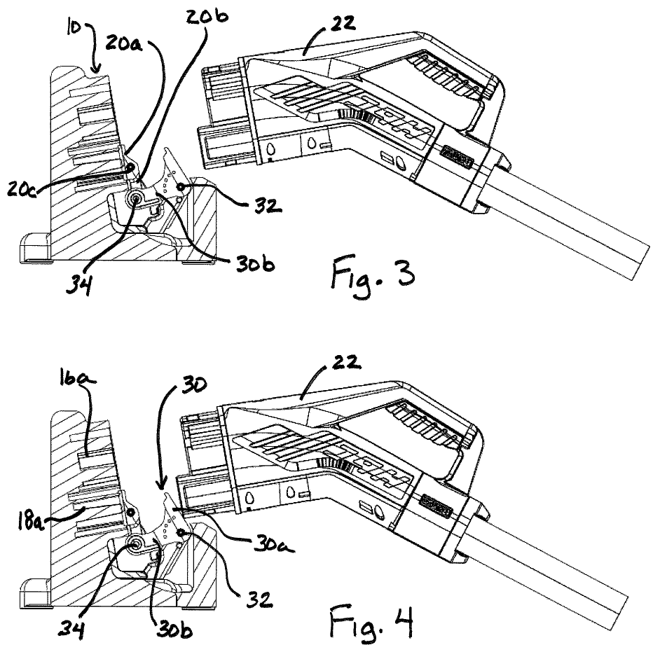

As seen in the transitional progression of FIGS. 4-7, when the charging port gun 22 is moved toward the charging port socket 18, the gun engages with and rotates the actuation device 30 about the pivot axis 32, which causes the pivot axis 34 to shift downward and outwardly away from the charging port socket 18, thereby causing the cover 20 to shift downward and outwardly away from the charging port socket 18 (per FIG. 5). As the cover 20 shifts downward and away, the pins 20c slide along the guide path of surface(s) of the guide rail(s) 22. Further rotation/pivot of the actuation device 30 causes the cover 20 to move further downward and inward toward a final access position in which the cover 20 is beneath the actuation plate component 30a as the charging gun 22 engages into the charging port socket (per FIG. 7). A biasing assembly (e.g. in the form of a torsion spring along the connection axis 32 or a leaf spring assembly below/behind the actuation plate component) urges the actuation device into the set position of FIG. 3, which in turn urges the cover 20 into the closed position of FIG. 3, such that when the charging gun 22 is disengaged and removed, the actuation device 30 and the cover 20 automatically return to these positions.

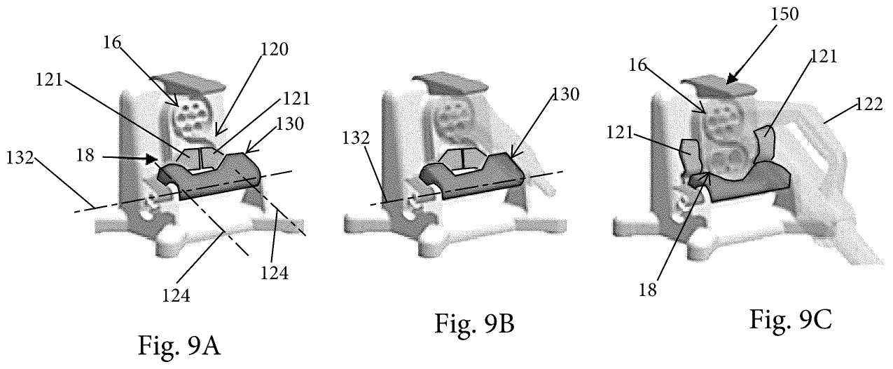

FIGS. 9A-9C show an alternative embodiment in which the charging port socket cover 120 includes a pair of cover components 121 that are pivotable about respective pivot axes 124. The actuation device 130 is pivotable about horizontal axis 132. Here, the pivot axes 124 are not parallel with the pivot axis 132, and may, in embodiments, be substantially perpendicular to the pivot axis 132. As the actuation device 130 is pivoted about the axis 132 by engagement with the charging gun 122, the actuation device 130 causes the cover components 121 to pivot/rotate in opposite directions to clear the DC charging port socket, thus providing the access position of FIG. 9C. The connection between the actuation device 130 and the charging port socket cover components 121 for this purpose may be any of a geared connection and/or a cammed connection and/or a levered connection and/or a pivoting connection to translate movement of the actuation device into movement of the charging port socket cover. An optional connector guide 150 is also shown. Biasing is provided and may be any suitable configuration (e.g., torsion spring or leaf spring) to urge the actuation device 130 into its set position that corresponds to the closed position (FIG. 9A) of the cover components 121.

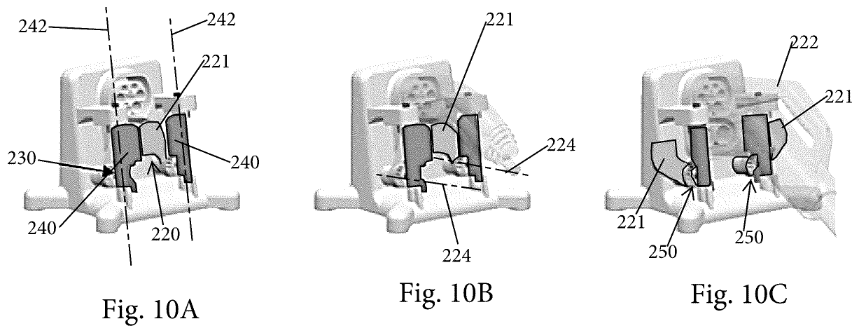

FIGS. 10A-10C show an alternative embodiment in which the charging port socket cover 220 includes a pair of cover components 221 that are pivotable about respective pivot axes 224. The actuation device 230 includes a pair of actuation structures/components 240 that are mounted for pivot/rotation about respective upright pivot axes 242. A geared connection 250 between each actuation component 240 and its corresponding cover component 221 is provided. The actuation structures/components 240 operate in the manner of swinging doors that are rotated in opposite directions when the charging gun is moved toward the charging port socket 18, thereby causing the cover components 221 to rotate in opposite directions to clear access to the charging port socket 18. Biasing is provided and may be any suitable configuration (e.g., a torsion spring associated with each actuation structure/component 240) to urge the actuation structures/components 240 into their set positions that correspond to the closed position (FIG. 10A) of the cover components 221.

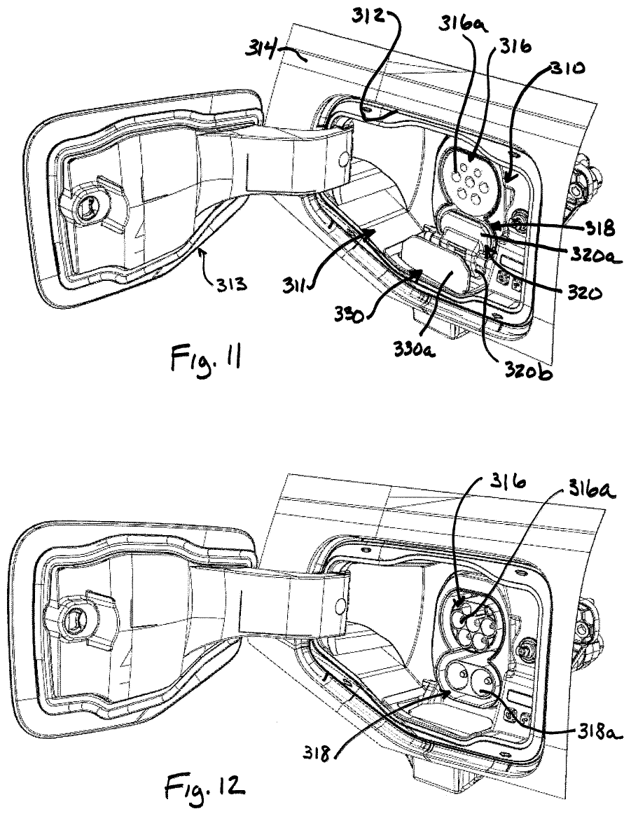

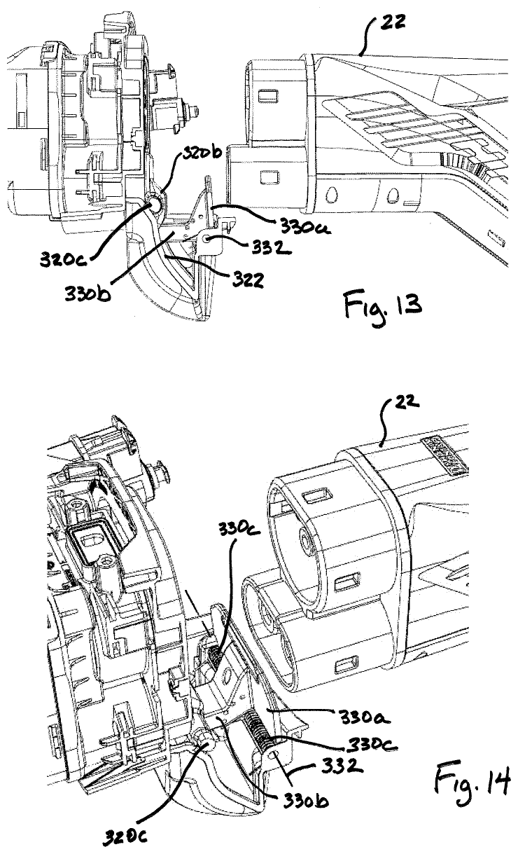

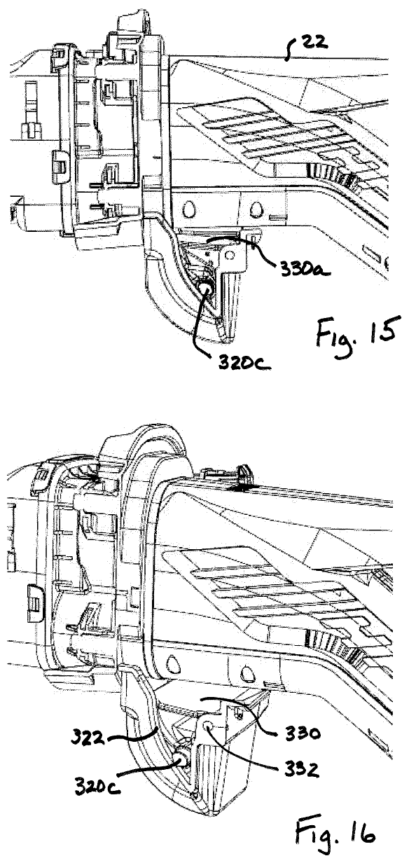

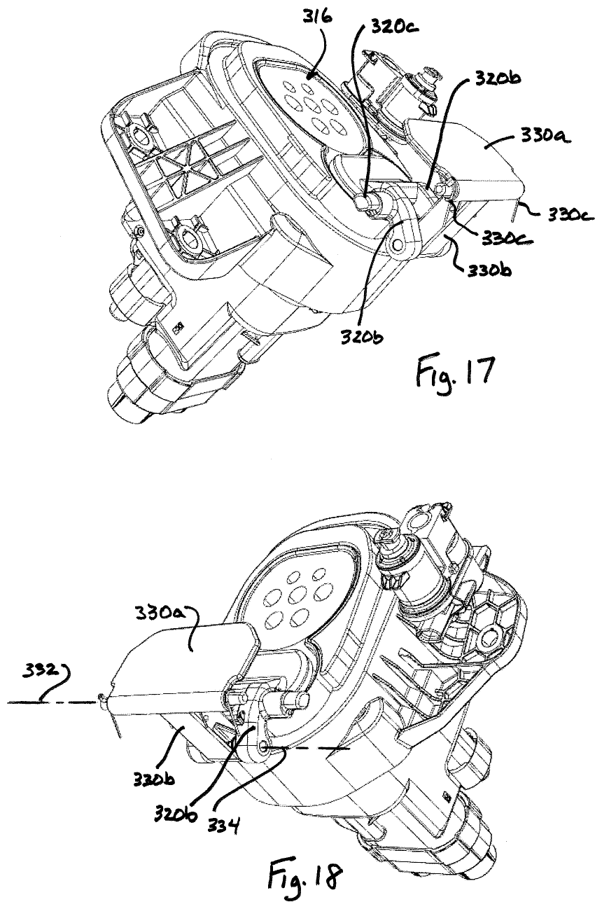

Referring now to FIGS. 11-18, another embodiment of a charging system, similar that of FIGS. 1-7, is shown and includes a charging housing 310 which is located in a charging compartment 311 accessible via an opening 312 of a vehicle body component 314 (e.g., a body panel), where a compartment door or flap 313 is provided an movable between closed and open positions. The housing 310 defines an AC charging port socket 316, with associated pins located in pin openings 316a, and a DC charging port socket 318, with associated pins located in pin openings 318a. The DC charging port socket includes an associated charging port socket cover 320 that, in a closed position (per FIG. 11) covers and protects the pins of the DC charging port socket 318, and that is movable to an access position (per FIG. 12) that uncovers the DC charging port socket 318 and enables a charging gun 22 to engage with the DC charging port socket 318.

Here, the charging port socket cover 320 includes a main cover plate 320a engageable over the DC charging port socket 318 when in the closed position, and an operating arm or arms 320b extending from the main cover plate 320a, with a pair of side pins 320c extending from the operating arm or arms 320b and ridable along a guide path defined by outwardly facing surfaces of respective side rails 322. An actuation device 330 includes an actuation plate component 330a that is mounted for pivotable movement about a horizontal pivot axis 332. The actuation device further includes an arm or arms 330b that extend from and pivot with the plate component 330a, and which are pivotably connected to a distal portion of the operating arm 320b such that the actuation device 330 and the cover 320 can pivot relative to each other about a horizontal pivot axis 334. Here, the pivot axis 332 is substantially parallel to the pivot axis 334.

When the charging port gun 22 is moved toward the charging port socket 318, the gun engages with and rotates the actuation device 330 about the pivot axis 332, which causes the pivot axis 334 to shift downward and outwardly away from the charging port socket 318, thereby causing the cover 320 to shift downward and outwardly away from the charging port socket 318. As the cover 320 shifts downward and away, the pins 320c slide along the guide path of surface(s) of the guide rail(s) 322. Further rotation/pivot of the actuation device 330 causes the cover 320 to move further downward and inward toward a final access position in which the cover 320 is beneath the actuation plate component 330a as the charging gun 22 engages into the charging port socket. A biasing assembly (e.g. in the form of a torsion springs 330c along the connection axis 32 or a leaf spring assembly below/behind the actuation plate component) urges the actuation device into the set position of FIG. 11, which in turn urges the cover 320 into the closed position of FIG. 11, such that when the charging gun 322 is disengaged and removed, the actuation device 330 and the cover 320 automatically return to these positions.

It is to be clearly understood that the above description is intended by way of illustration and example only and is not intended to be taken by way of limitation. Still other variations and configurations are possible.

1. An actuation device for moving a charging port socket cover of a charging port socket from a closed position to an access position, where the charging port socket is received or receivable on a body component of a vehicle, the actuation device comprising:
a movable actuation structure associated with the charging port socket cover and configured such that movement of a charging gun into contact with the actuation structure and toward the charging port causes the actuation structure to shift the charging port socket cover from the closed position toward the access position.

2. The actuation device of claim 1, wherein the actuation structure is pivotable and the charging port socket cover is pivotable.

3. The actuation device of claim 2, wherein the actuation structure comprises at least one actuation component mounted for pivot about a first pivot axis and the charging port socket cover comprises at least one cover component mounted for pivot about a second pivot axis.

4. The actuation device of claim 3, wherein the first pivot axis and the second pivot axis are not parallel with each other.

5. The actuation device of claim 4, wherein the first pivot axis is an upright axis and the second pivot axis is a horizontal axis.

6. The actuation device of claim 3, wherein the first pivot axis is substantially parallel to the second pivot axis.

7. The actuation device of claim 6, wherein the first pivot axis is a horizontal axis and the second pivot axis is a horizontal axis.

8. The actuation device of claim 1, wherein the actuation structure is pivotable and the charging port socket cover is slidable along a guide path.

9. The actuation device of claim 8, wherein the actuation structure is also pivotably connected to the charging port socket cover.

10. The actuation device of 8, wherein a pivot connection is provided between the actuation structure and the charging port socket cover and a pivot axis of the pivot connection is moved as the charging gun moves the actuation structure.

11. The actuation device of any of claim 10, wherein the guide path is at least partly outward and downward from the charging port socket.

12. The actuation device of claim 1, wherein the actuation structure is biased into a set position that corresponds to the closed position of the charging port socket cover such that, upon removal of the charging gun, the actuation structure automatically returns to the set position and the charging port socket cover automatically returns to the closed position.

13. The actuation device of claim 1, wherein the actuation structure is interconnected with the charging port socket cover by:
at least one gear connection to translate movement of the actuation structure into movement of the charging port socket cover;
and/or
at least one cammed connection to translate movement of the actuation structure into movement of the charging port socket cover;
and/or
at least one levered connection to translate movement of the actuation structure into movement of the charging port socket cover;
and/or
at least one pivot connection to translate movement of the actuation structure into movement of the charging port socket cover.

14. A vehicle comprising a body component with a charging compartment comprising the actuation device of claim 13 therein.

15. A method of operating a charging system of a vehicle, comprising:
utilizing a charging port socket with a charging port socket cover that is movable from a closed position to an access position, wherein an actuation structure is linked to the charging port socket cover for moving the charging port socket cover;
moving a charging device toward the charging port socket and into engagement with the actuation structure causing a movement of the actuation structure that, in turn, causes the charging port socket cover to move from the closed position to the access position such that the charging device can engage with the charging port socket.

16. A vehicle charging assembly, comprising:
a charging compartment within a vehicle body component;
a charging port socket in the charging compartment;
a charging port socket cover movable from a closed position that covers the charging port socket and an access position that uncovers the charging port socket;
a movable actuation structure linked to the charging port socket cover and configured such that movement of the actuation structure out of a set position shifts the charging port socket cover from the closed position toward the access position.
